(19) United States
(12) Patent Application Publication
(10) Pub. No.: US 2015/0343721 A1
(43) Pub. Date: Dec. 3, 2015

(54) DEVICE AND METHOD FOR MANUFACTURING FIBER-COMPOSITE COMPONENTS, AND FIBER-COMPOSITE COMPONENT

(71) Applicant: Benteler SGL GmbH & Co. KG, Paderborn (DE)

(72) Inventors: Johannes GRAF, Ried im lnnkreis (AT); Dominik KAISER, Ried im lnnkreis (AT); Ralph KIESSLING, Ried im lnnkreis (AT); Jan KURZ, Ried im lnnkreis (AT); Dennis KLEINHANS, Paderborn (DE); Johannes BOEKE, Blomberg (DE); Marko MACIEJ, Paderborn (DE)

(21) Appl. No.: 14/722,938

(22) Filed: May 27, 2015

(30) Foreign Application Priority Data
May 28, 2014 (DE) 10 2014 107 584.6

(51) Int. Cl. B29C 70/54; B60G 11/02; B29C 70/48

(52) U.S. Cl. CPC B29C 70/548; B29C 70/48; B60G 11/02; B29L 2031/774

(57) ABSTRACT

A device for a resin-injection process for manufacturing an elongate fiber-composite component is disclosed having an upper die and a lower die, wherein the lower die forms a mold cavity for receiving a fiber-layer stack. The inner contour of the mold cavity substantially corresponds to the outer contour of the fiber-composite component to be produced. The device includes a gate 4 for introducing a matrix material into the mold cavity 5, and flow ducts which convey the matrix material are provided on the inner walls of the mold cavity. A method for manufacturing elongate fiber-composite components is disclosed, wherein a stack of a plurality of cut-to-size fiber layers is laid up in the mold cavity of a die comprising an upper die and a lower die. A higher fiber density is produced in the end regions of the stack of fiber layers than in the remaining regions when closing the die.

### CROSS-REFERENCE TO RELATED APPLICATIONS

This application is claims the benefit of German Application No. 10 2014 107 584.6, filed May 28, 2014, which is incorporated herein by reference in its entirety.

The invention relates to a device for a resin-injection process for manufacturing an elongate fiber-composite component. Furthermore, the invention relates to a method for manufacturing elongate fiber-composite components, and to a corresponding fiber-composite component per se.

The manufacture of fiber-composite components from fiber-reinforced plastics is known from the prior art. One possibility for manufacturing is for dry fiber material in suitable devices to be infiltrated by resin, and for the pressure resin and the matrix resin to then be cured under the influence of pressure and heat, and to manufacture a fiber-composite component in this way.

For this purpose, individual layers of a fiber material, such as carbon or glass or similar, for example, are cut to size and stacked on top of one another. Mostly, these fiber layers are fixed on one another using an adhesive which may be available in a liquid or solid form, for example as a powder, in order to avoid unintentional slipping of the individual fiber layers in relation to one another. The fiber layers, post or prior to stacking, are cut and already premolded, if applicable. That is to say that they are already in the final shape of the component, or at least a shape which is similar to that of the final component. This semi-finished product is referred to as a preform.

The preform is laid up in a molding die which is composed mostly of an upper and a lower die, wherein the latter may in each case be implemented so as to be in one part or multiple parts. Once the preform has been laid up, the die is closed and a liquid matrix resin is injected into the mold cavity. Thermoplastic and duroplastic materials which are known to a person skilled in the art are mostly employed as matrix materials. The selection of the matrix materials here is to a large extent influenced by the presupposed mechanical properties of the finished component as well as by the properties of the liquid matrix material which are relevant to production, such as viscosity, for example.

The matrix material then fully penetrates through the fiber layers, wherein uniform impregnation is preferably desired. In order for the impregnation of the fiber layers to be supported, negative pressure is generated in the mold cavity of the die, mostly by way of a vacuum pump connected thereto, on account of which the risk of undesirable trapped air in the finished component is also to be minimized. This simultaneously serves to support the impregnation of the fiber layers.

As soon as the mold cavity of the die is completely filled with matrix material, the inflow of the matrix material is stopped and the curing process for the matrix material is started. The matrix material is cross-linked under the influence of pressure and heat, and forms a solid prime material.

The inner contour of the mold cavity of the die here is designed such that the former corresponds to the outer contour of the finished component.

Once the component has been completely or almost completely cured, it is removed from the die and, if applicable, subjected to final curing in an oven. Thereafter, downstream operational steps, such as deburring, cutting, or else polishing are performed, if applicable, on account of which the component is finally completed.

It is particularly important in this manufacturing method that the fiber material prior to curing is completely impregnated with the matrix material. If this is not the case, for example when air bubbles are trapped in the mold cavity and, in particular, between and in the fiber layers, there is the risk of dry fiber layers remaining in the completed component. Such manufacturing faults, even if they are minute, lead to a drastic reduction of the service life under dynamic stress on such a component. In the region of the dry fiber layers there is the risk of the fibers per se tearing easily or of the individual fiber layers delaminating. Likewise, the corresponding fault spots, when excessively stressed, form a breeding ground for cracks and consequently ruptures in the component.

The cause of such fault spots is often to be sought in the inhomogeneous impregnation of the fiber material with the matrix material. Impregnation is not performed in a uniform manner in all directions, rather the matrix material preferably spreads out in the plane of the individual fiber layers. Flow resistance is at its lowest there, such that the flow front can most rapidly spread out in the plane of the fiber layers. Perpendicular to the plane of the fiber layers, that is to say going through the individual fiber layers, flow resistance is particularly high, since there are no lineally continuous flow ducts here. This means that, proceeding from the gate point at which the matrix material is introduced into the mold cavity, the fiber layers which are closest to the gate are very rapidly and efficiently impregnated, whereas the fiber layers which are more distant from the gate are impregnated only later.

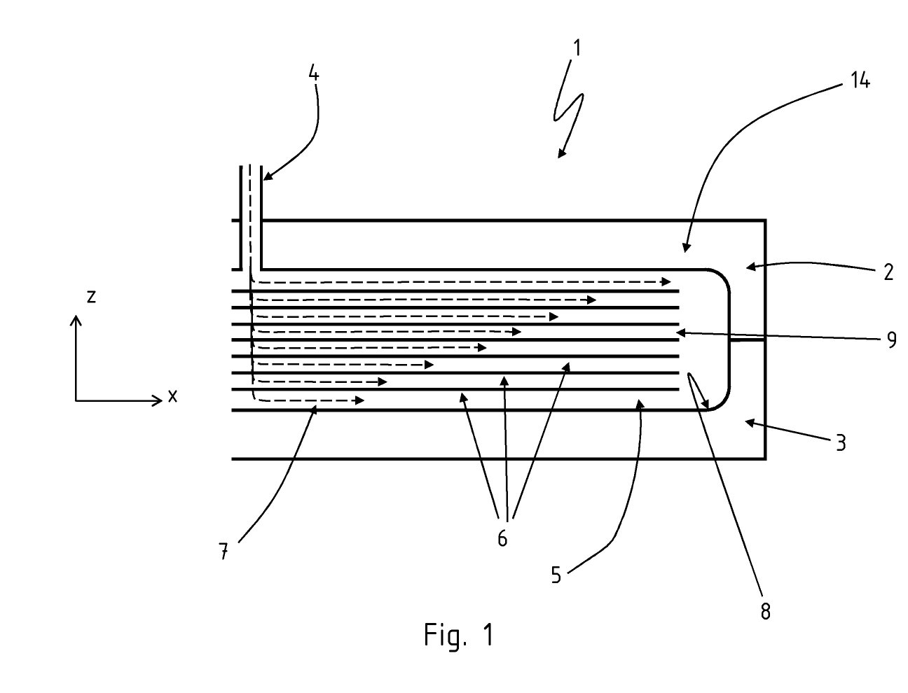

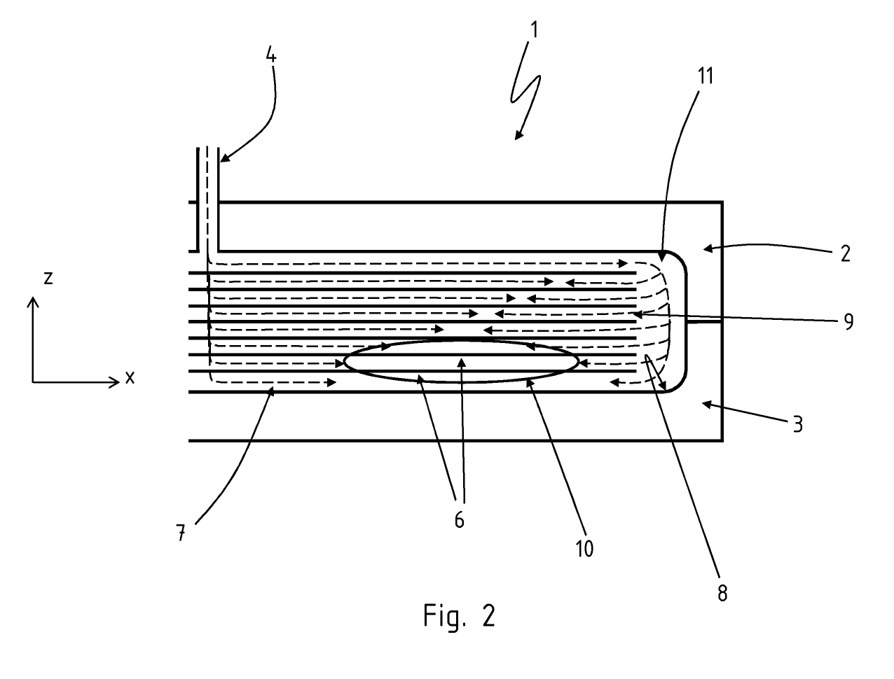

This is highlighted in a schematic manner in FIGS. 1 and 2. FIGS. 1 and 2 illustrate devices from the prior art for a resin-injection process for manufacturing fiber-composite components. Illustrated is a device 1 for a resin-injection process, having an upper die 2 and a lower die 3, into the mold cavity 5 of which a stack of individual fiber layers 6 is laid up. Matrix material which spreads out along specific spreading directions 7 in the mold cavity 5 is injected through a gate 4. It is evident from FIG. 1 that spreading occurs very rapidly parallel to the planes of the fiber layers 6, or else between the fiber layers 6, specifically more rapidly the closer a fiber layer 6 is positioned to the gate 4. Penetration of the fiber material in a perpendicular manner to the plane of the fiber layers 6 occurs more slowly, such that fiber layers 6 which are disposed so as to be more distant from the gate 4 are more slowly impregnated.

In particular, spreading of the matrix material between the inner wall 8 of the mold cavity 5 and the first fiber layer 6 adjoining thereto is particularly rapid. This leads to the matrix material being able to flow around the entire fiber-layer stack and, as shown in FIG. 2, to flow back again from the end region 9 of the fiber-layer stack in the direction of the gate 4. On account thereof, trapped air 10 is created, since the residual air which is present in the mold cavity 5 can no longer escape from the device 1 but is trapped between the flow fronts running toward one another. Here, the individual fiber layers 6 remain dry and form the above-described fault spots.

A plurality of solutions for alleviating this problem are known from the prior art. In this way, DE 198 50 462 A1, for example, discloses a die for manufacturing a plastic molded part, which is provided with flow ducts on the inner walls of the die. On account of the flow ducts, the matrix material spreads out in a directed manner in the interior of the die. The matrix material here is injected from the side into the mold cavity, between the two halves of the molding die.

DE 10 2012 215 189 A1 describes a die set for producing a fiber-composite component of variable thickness. Here, the problem of variable impregnation intensity of the variably thick portions of the fiber-composite material is solved in that the single gate duct has a cross-sectional area which is adapted to the respective thickness of the component. In the case of thicker portions of the fiber-composite component, the cross section of the gate duct is also designed so as to be larger in order to provide a larger amount of resin for impregnation.

The two devices described do indeed make it possible for uniform impregnation of the composite component to be achieved in the respective case, but flow diversion around the entire fiber-material stack and the dry spots in the finished component caused thereby are actually not prevented on account thereof. It is in particular in the case of thick components that such a manufacturing fault increasingly occurs. As the layer count in the fiber-material stack increases, the capability of the matrix material to impregnate the material in a perpendicular manner to the plane of the fiber layers drops. Penetration is already heavily impeded from a component thickness of 6 to 8 layers onward. Reference is then made to a thick component already from this layer count onward. In addition, impregnation is compromised as the packing density of the fibers increases.

Impregnation of fiber-material stacks which have additional layers of another material or cores embedded between one or a plurality of layers of the fiber material is likewise problematic. These may be metallic layers for the reinforcement of the component to be produced, for example. For example, it is conceivable for the fiber stack to be constructed such that 6 to 8 layers of the fiber material are followed by an intermediate layer of a metallic material, which in turn is covered by a further 6 to 8 layers of a fiber material. Here too, impregnation of the entire preform is difficult to achieve.

It is the object of this invention to provide a device which in the manufacture of a fiber-composite component allows uniform impregnation of the fiber material. Likewise, a method by way of which a fibrous component can be uniformly impregnated is to be provided. Furthermore, a corresponding fiber-composite component is to be proposed.

The object relating to a device is achieved by a device for a resin-injection process according to claim 1. Particular embodiments of the device are described in claims 2 to 9.

The process-technological part of the object is achieved by a method for manufacturing fiber-composite components according to patent claim 10. The preferred embodiments of the method are stated in claims 11 and 12.

Furthermore, the invention relates to an elongate fiber-composite component as claimed in claim 13 or 14.

The object is thus achieved by a device for a resin-injection process for manufacturing an elongate fiber-composite component, in particular a leaf spring for a motor vehicle, having an upper and a lower die which collectively form a mold cavity for receiving a fiber-layer stack, wherein the inner contour of the mold cavity substantially corresponds to the outer contour of the fiber-composite component to be produced. Furthermore, the device disposes of a gate for introducing a matrix material into the mold cavity which is disposed in a central region of the device. Flow ducts for conveying matrix material are provided on the inner walls of the mold cavity, wherein flow ducts of a first type, proceeding from the gate, extend in a longitudinal direction of the mold cavity toward the peripheral regions of the mold cavity. Moreover, an outlet for attaching a vacuum pump is provided. The invention is characterized in that means for increasing the fiber density in the end regions of the fiber-layer stack are provided in the peripheral regions of the mold cavity.

An elongate fiber-composite component is defined in that its spatial extent in one direction (direction X) is very much larger than the extent in the other two spatial directions (direction Y, direction Z). The direction X here is also referred to as the longitudinal direction of the fiber-composite component.

As described above, individual fiber layers are cut to size and assembled to form a fiber-layer stack. This stack is introduced into the mold cavity of the device and infiltrated by matrix material after closing the device.

The inner contour of the mold cavity here substantially corresponds to the outer contour of the fiber-composite component to be produced. This means that the final product differs only slightly from the fiber-composite component which has been demolded from the mold cavity. The flow ducts are open toward the mold cavity and are filled with matrix material at the start of the curing operation. This means that after curing the flow ducts are reproduced as protrusions or matrix regions on the outer contour of the fiber-composite component. However, these protrusions do not belong to the outer contour of the fiber-composite component per se and may thus be removed by abrasion or cutting in a further processing step. Accordingly, the inner contour of the mold cavity is not identical with the outer contour of the fiber-composite component to be produced, but only substantially corresponds to the outer contour.

The flow ducts may be channels or grooves which are milled into the inner wall of the mold cavity. The flow ducts of the first type predominantly extend so as to proceed from the gate in a longitudinal direction of the mold cavity. However, they need not be configured in a lineal manner, but may also be configured so as to be meandering or undulating. They serve to direct the matrix material as rapidly as possible and in a targeted manner to the desired points.

The flow ducts of the first type here need not directly exit at that point at which the matrix material is introduced into the mold cavity. Besides a filling duct, the gate may also dispose for example of a distribution duct via which the matrix material is distributed toward the flow ducts of the first type. When the matrix material spreads out in the mold cavity, the matrix material pushes the residual air in front of it in the direction of the outlet which, for this purpose, preferably is attached to a peripheral region of the mold cavity. In order to support this ventilation operation, in most cases a vacuum pump is attached to the outlet.

In order to enable uniform impregnation of the fiber material with the matrix material it is particularly necessary for the gate to be mounted in a central region of the component, such that the total path between the gate and the peripheral region of the mold cavity which has to be impregnated by the matrix material is kept as short as possible.

The problematic return flow of the matrix material from the end of the fiber-layer stack back into the fiber layers which have not yet been infiltrated is excluded in that means for increasing the fiber density in the end regions of the fiber-composite component are provided in the peripheral regions of the mold cavity. The fiber density here is understood to be the number of fibers per volume of the component. The end regions of the fiber-composite component extend only a few centimeters away from the end of the fiber-layer stack toward the gate of the device. On account thereof that the fiber density in these regions is increased, flow resistance to the matrix material is significantly increased. A higher fiber density may be produced by compressing the fiber layers. On account thereof it is prevented that the matrix material can penetrate from the peripheral regions of the mold cavity into the fiber layers which have not yet been impregnated. Consequently, the fiber layers which have not yet been impregnated may exclusively be impregnated, emanating from the gate, with matrix material, as is desirable, wherein the residual atmosphere in the mold cavity is blown by the flow front in the direction of the outlet, such that no air bubbles are trapped in the mold cavity and between the fiber layers.

The fiber-layer stack is consequently completely impregnated, on account of which after the curing operation a faultless fiber-composite component is produced.

In order for this impregnation to be even further supported, flow ducts of a second type, which extend along a height direction of the mold cavity so as to branch out from the flow ducts of the first type, may be provided. That direction which points in a perpendicular manner to the plane of the fiber layers (direction Z) is to be understood as the height direction of the mold cavity. It is precisely this spreading direction of the matrix material that has to struggle against an increased flow resistance, since hardly any ducts which have been formed in a lineal manner through the fiber layers are present in the fiber material in this direction. By way of the flow ducts of the second type the matrix material is conveyed in an extremely efficient manner to the fiber layers which are disposed so as to be comparatively more distant from the gate. The matrix material flows past the individual layers and in this way may penetrate from the side into the fiber layers. This means that penetration of the fiber layers by the matrix material is not only performed in the longitudinal direction of the fiber-composite component, but additionally from the side. This is particularly desirable if and when the fiber-layer stack has a comparatively large thickness on account of a multiplicity of individual fiber layers. A thick fiber-layer stack is already understood to be a stack having a layer count of 6 to 8 layers. Already with this low number of fiber layers, impregnation in a perpendicular manner to the layer plane is heavily impeded.

Impregnation becomes intensely inhomogeneous even in the case of intermediate layers or cores of other materials, for example metallic materials, being used within the fiber-layer stack, such that flow ducts of the second type enable uniform and targeted impregnation of the fiber-layer stack, here too.

Preferably, the flow ducts of the second type are disposed so as to branch out from the flow ducts of the first type in parallel with a demolding direction. This is advantageous during later demolding of the finished cured component from the mold cavity, since no undercuts are produced then by the flow ducts of the second type.

It has been demonstrated that it is also advantageous for the flow ducts of the second type to be uniformly spaced apart in the longitudinal direction of the mold cavity. The spacing of the individual flow ducts of the second type here is to be selected such that said spacing is adapted to the flow speed of the matrix material in the longitudinal direction of the mold cavity. The spacing of the flow ducts of the second type is to be selected such that a flow front as uniform as possible is produced in the entire fiber-layer stack, without trapped air being a possibility. Further influences here come from the type of fiber materials, the viscosity of the matrix material, and the number of individual layers in the fiber-layer stack.

Furthermore the flow ducts of the first and/or second type preferably have variable cross-sectional areas. The flow speed of the matrix material in the fiber material may also be influenced with the aid of this parameter, such that a uniform flow front is produced.

It is possible here for both, the cross-sectional area of a flow duct to vary in portions across its length, or it may also be provided here that individual flow ducts among one another have variable cross-sectional areas.

Preferably here, the average cross-sectional area of a flow duct of the second type is smaller the more distant the flow duct of the second type is disposed from the gate.

In order for a uniform flow front to be produced, the flow ducts preferably are disposed so as to be symmetrical to a central longitudinal plane of the mold cavity. The central longitudinal plane is defined by the direction X and the direction Z and divides the device (the upper and the lower die) into two halves in the longitudinal direction.

To this end, preferably one or a plurality of inserts for reducing the mold cavity volume are provided in the peripheral regions of the mold cavity. In order for the fiber density to be increased in the end regions of the fiber-layer stack, the fiber layers are compressed.

This may be achieved in that the volume of the mold cavity in the peripheral regions thereof is reduced. To this end, preferably one or a plurality of inserts for reducing the mold cavity volume are provided in the peripheral regions of the mold cavity. Said inserts are laid up together with the fiber-layer stack into the peripheral regions of the mold cavity. The inserts may be composed of various materials, such as, for example, of metal, Teflon, wood, glass, or even elastomeric materials. When closing the device, the end regions of the fiber-layer stack are squeezed on account of the inserts, such that a higher localized fiber density is produced there, on account of which in turn the flow resistance to the matrix material is increased.

Two effects are achieved on account thereof. On the one hand, the matrix material which spreads out between the first layers of the fiber material, that is the layers which are disposed so as to be closest to the gate, can only re-exit with difficulty from the end region of the fiber-layer stack. This means that the amount of matrix material which flows around the end of the fiber-layer stack is less. At the same time, re-entry of the matrix material into the dry fiber layers which have not yet been impregnated is likewise made difficult, on account of which the trapping of air bubbles is prevented, as has been described above.

The inserts are then removed again, once the finished fiber-composite component has been removed from the mold cavity, and may also be reused, if applicable.

It is provided in another variant that protrusions for reducing the mold cavity volume are provided on the inner walls of the upper and/or lower dies, in the peripheral regions of the mold cavity. The fundamental principle here is the same as above. On account of the protrusions in the die parts, the mold cavity volume is reduced, and on account thereof the fiber layers are compressed when closing the die, which is associated with increasing the fiber density. The consequential effects are identical with those when inserts are used. Here too, avoidance of trapped air, and thus dry spots in the fiber-composite component, is observed.

The method according to the invention for manufacturing elongate fiber-composite components, in particular leaf springs for a motor vehicle, provides the following method steps:
providing a stack of a plurality of cut-to-size fiber layers;
placing the fiber-layer stack in the mold cavity of a die comprising an upper die and a lower die;
closing the die;
introducing matrix material into the mold cavity of the die through a gate which is disposed in a central region of the die, wherein the matrix material penetrates into the fiber layers and is simultaneously directed along flow ducts on the inner walls of the mold cavity, such that the stack of fiber layers is uniformly impregnated;
curing the resin while applying pressure and heat, wherein an elongate fiber-composite component is produced.

The method is characterized in that a higher fiber density is produced in the end regions of the fiber-layer stack than in the remaining regions when closing the die.

In the manufacture of the fiber-layer stack it is possible for both, individual fiber layers to be cut to size and then to be placed on top of one another in order to form a fiber-layer stack, as well as for a stack of uncut fiber layers to be tiered and for the fiber-layer stack per se to be severed as a whole from the uncut stack, in particular punched or cut therefrom. The individual layers of the fiber-layer stack are fixed among one another. This may be performed, for example, by way of a liquid adhesive, a dry adhesive powder, or else by stitching.

The fiber-layer stack in the context of the invention need not exclusively be composed of individual fiber layers; it may also be provided for layers of other materials, for example, metallic intermediate layers or cores, to be a component part of the fiber-layer stack. It is then possible, for example, for sandwich constructions to be carried out, which are reinforced by the additional inserts, or for the fiber-layer stacks to be produced, which have properties which are provided in a localized manner.

The fiber-layer stack is then placed into a die, and a higher fiber density than in the remaining regions of the stack is produced in the end region of the fiber-layer stack when closing the die. As a consequence, flow resistance to the matrix material in this end region is higher than in the remaining regions. This means that this region of the stack of fiber layers is not impregnated by the matrix material at the same speed as in regions with lower fiber density.

At the same time, the matrix material which is introduced into the mold cavity of the die is directed along flow ducts on the inner walls of the mold cavity, such that a uniform flow front is created and the fiber-layer stack is uniformly impregnated.

The fiber layers which are disposed so as to be directly adjacent to the gate are particularly rapidly impregnated in the longitudinal direction of the fiber-composite component. However, impregnation is hindered by the high fiber density in the end region of the fiber-layer stack. The matrix material then does not re-exit too rapidly from the end of the fiber-layer stack, and thus cannot flow back into the layers of the stack which are still dry and which are disposed so as to be more distant from the gate. The formation of undesirable air bubbles which lead to dry component spots is thus avoided.

When or after closing the die, external pressure is applied in order to keep the die closed during injection of the matrix material. At the same time, the die may already be temperature controlled at this point in time, in order to maintain an envisaged viscosity of the matrix material, for example.

As soon as the fiber-layer stack has been completely impregnated, the matrix material is cured under the influence of pressure and/or heat.

Here, depending on the matrix material, a specific temperature range, i.e. the curing temperature, has to be set. The fiber-composite component may be completely cured in the die, or even may also be removed from the die at an earlier stage and be completely cured in a curing oven, for example in order to shorten the cycle times.

Producing a higher fiber density in the end region of the fiber-layer stack when closing the die may be achieved in various ways. In one preferred embodiment of the invention additional fiber pieces are introduced into the end regions of the stack when producing the stack of the fiber layers. In this case, the die may remain unmodified. Only the end region of the fiber-layer stack is more heavily compressed than the remaining regions of the stack when closing the die, such that a higher fiber density is produced there. This variant offers the particular advantage that existing dies do not have to be redesigned at high cost. Moreover, this design embodiment of the invention enables the end regions of the finished fiber-composite component to be designed in a more bending resistant manner, which has a positive effect on potential interaction with other components, for example in a motor vehicle chassis. On account thereof it is likewise possible for individual fiber pieces, of which the fiber orientation may be selected so as to be variable, to be introduced, such that the peripheral regions of the component may be adapted to the desired properties.

Another preferred embodiment of the method provides that the end regions of the stack of fiber layers, on account of peripheral regions of the die which have a reduced height, are more heavily compressed than the remaining regions when closing the die. The reduction of the height of the mold cavity of the die (the direction Z is referred to here) is achieved by protrusions in the peripheral regions of the die, for example. On account thereof, the available volume of the mold cavity in the peripheral region of the die is reduced. On account of the reduced volume, the end region of the fiber-layer stack is more heavily compressed, and a higher fiber density than in the remaining regions of the fiber-layer stack is thus likewise produced.

In the context of the invention it is also possible for these two preferred variants to be combined with one another, in order to optimize the adjustment of the fiber density in the end regions of the fiber-layer stack.

Furthermore, an elongate fiber-composite component, in particular a leaf spring for a motor vehicle, having a central portion and end regions which are spaced apart by the central portion, is claimed, characterized in that the end regions have a higher fiber content than the central portion.

Such a fiber-composite component preferably is manufactured according to a method as described above, or manufactured in a device as likewise described above.

Particularly preferably, the fiber content in the central portion of the fiber-composite component is 50% to 65%, and in the end portions 60% to 75%.

Further advantages and features of the present invention are derived from the following drawings. Here, all described and/or depicted features, individually or in any meaningful combination with one another, form the subject matter of the present invention, also independently of their grouping in the claims or the dependent claims. In the drawings:

FIG. 1 shows a schematic illustration of the flow of the matrix material in a resin-injection die from the prior art;

FIG. 2 shows a further illustration of the resin-injection die from the prior art;

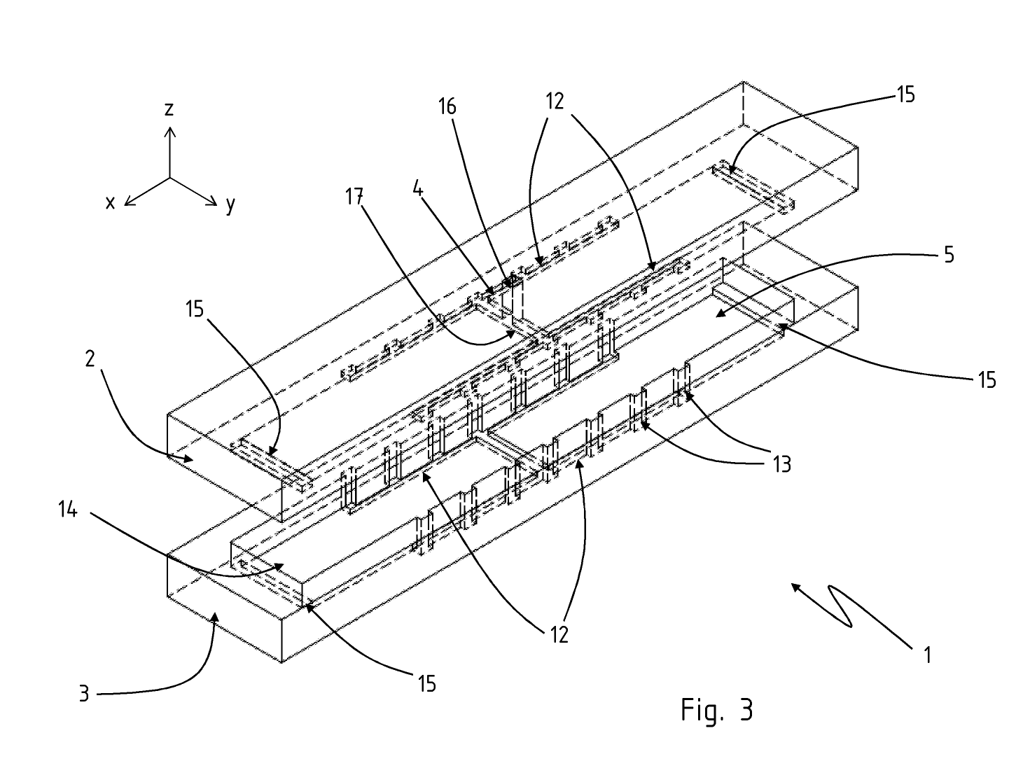

FIG. 3 shows a device according to the invention for a resin-injection process;

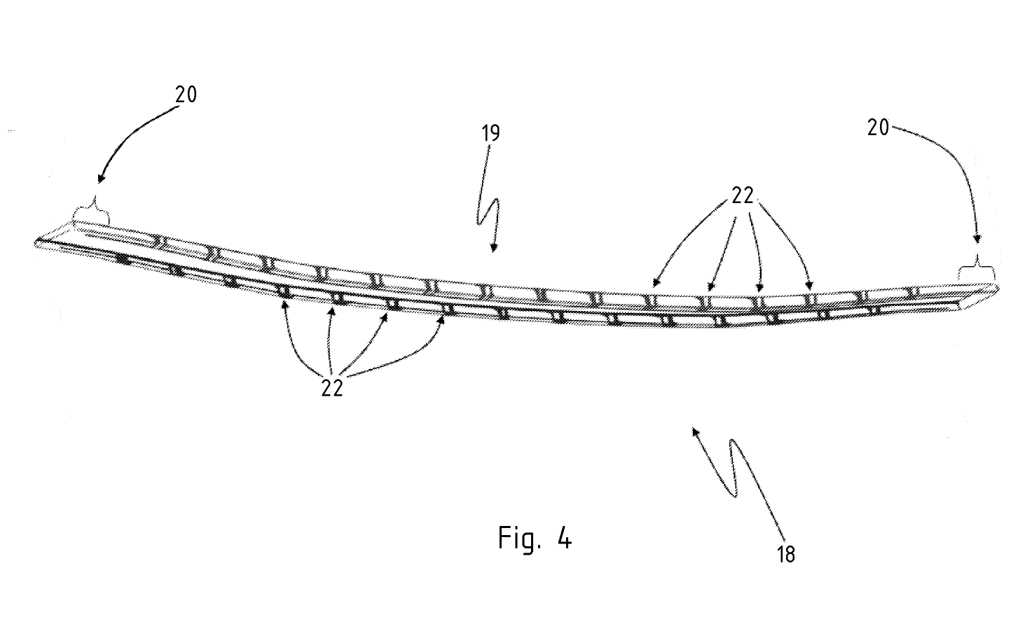

FIG. 4 shows a fiber-composite component according to the invention;

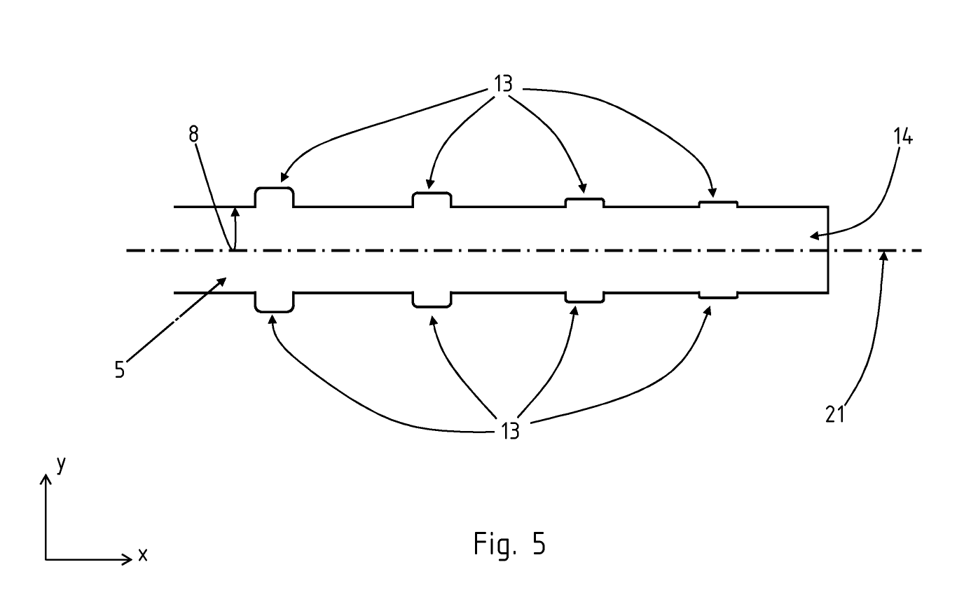

FIG. 5 shows the mold cavity of a device according to the invention in the plan view.

FIG. 1 has already been explained in an introductory manner. Here, a device for a resin-injection process from the prior art is schematically shown. For the purpose of simplification, only one half of a device according to the invention has been illustrated. The device 1 is composed of an upper die 2 and a lower die 3, which collectively form a mold cavity 5. A stack of fiber layers 6 is inserted into the mold cavity 5. Matrix material, preferably duroplastic or thermoplastic material and industry-standard matrix resins, is directed into the mold cavity 5 through a gate 4 which is centrically disposed, such that the matrix material is distributed along the spreading directions 7 in the mold cavity 5 and in this case impregnates the stack of fiber layers 6.

The state some time after the resin injection has started is illustrated in FIG. 1. It becomes evident here that, depending on the spacing of the individual fiber layers 6 from the gate 4, impregnation of said fiber layers 6 occurs at different speeds. The spreading direction from the gate 4 to the peripheral region 14 of the mold cavity 5 is referred to as the longitudinal direction or direction X. The direction in the drawing plane is the direction Y, and the remaining direction which is perpendicular to the plane of the fiber layer 6 is referred to as the direction Z. Spreading of the matrix resin in the planes X and Y occurs particularly rapidly, such that the fiber layers 6 which are disposed so as to be closest to the gate 4 are impregnated in a comparatively intense manner, while the fiber layers 6 which are disposed so as to be more distant have not yet been subjected to complete impregnation.

The further progress of impregnation is illustrated in FIG. 2. The matrix resin reaches the longitudinal-side end region 9 of the stack of fiber layers 6 and penetrates into a void region 11 which exists between the stack of fiber layers 6 and the end-side inner wall 8 of the mold cavity 5. This void region 11 is necessary for the ends of the individual fibers of the fiber layers 6 to also be completely surrounded by the matrix material. The matrix material in the void region flows around the stack of fiber layers 6 and penetrates into the fiber layers which are disposed so as to be more distant from the gate 4 and which have not yet been impregnated. On account thereof, a second flow front which again moves in the direction of the gate 4 is created. Trapped air 10 is formed between the first flow front, which moves in the direction of the end of the fiber-layer stack, and the oncoming second flow front. In this region, the fiber layers 6 remain dry and are not wetted by the matrix material. The finished component here has a fault spot and highly compromised properties in terms of durability and susceptibility to faults.

A device 1 according to the present invention for a resin-injection process is schematically illustrated in FIG. 3. The device 1 is composed of an upper die 2 and a lower die 3. Both part-dies collectively form a mold cavity 5 for receiving a fiber-layer stack. The inner contour of the mold cavity 5 substantially corresponds to the outer contour of the fiber-composite component to be produced. A gate 4 is centrically disposed. Said gate 4 is composed of a filling duct 16, through which the matrix resin is introduced into the mold cavity 5, and a distribution duct 9, which conveys the matrix resin in the direction Y to the flow ducts. The flow ducts 12, 13 which are provided on the inner wall 8 of the mold cavity 5 serve the purpose of distributing the matrix material as efficiently as possible in the mold cavity 5 of the device 1. The flow ducts of the first type 12 here extend in the longitudinal direction of the mold cavity 5 toward the peripheral regions 14 of the mold cavity 5.

Flow ducts of the second type 13 which extend in a perpendicular manner so as to branch out in the direction Y from the flow ducts of the first type 12 are provided in the present exemplary embodiment. The flow ducts of the second type 13 are uniformly spaced apart from one another. It is their task to convey the matrix material as efficiently as possible to the fiber layers which are disposed so as to be more spaced apart from the gate 4. Without the flow ducts of the second type 13, the corresponding fiber layers 6 are not effectively impregnated, since the flow resistance in such a stack of fiber layers 6 in the direction Z is very high. The flow ducts of the second type 13 form a bypass, so to speak, which conveys the matrix resin past the fiber layer stack to the nether fiber layers 6. On account thereof, it is achieved that the impregnation of these fiber layers 6 does not exclusively depend on the matrix material slowly trickling through the individual fiber layers 6. The fiber layers 6 which are disposed so as to be more distant are then also impregnated from the side with matrix resin, benefiting the configuration of a more uniform flow front.

In this exemplary embodiment the flow ducts of the first type are configured so as to be lineal. However, it may be expedient for these flow ducts of the first type 12 to be disposed in undulating lines or, in another manner, so as to meander. The specific implementation always depends on the geometry of the fiber-composite component to be produced or on the matrix material used, respectively. Depending on the viscosity and wetting properties of the latter, the flow front which is produced will also regularly be shaped in various manners, such that the flow ducts of the first type 12 and of the second type 13 have to be adapted to the respective preconditions.

In order for the fiber density to be increased in the end regions 20 of the fiber-composite component, protrusions 15 which are disposed in the upper die 2 and the lower die 3 in the peripheral region 14 of the mold cavity 5 are provided in this exemplary embodiment. The extent of these protrusions in the direction X is only a few centimeters. In this peripheral region 14 the stack of fiber layers 6 is more heavily compressed than in the remaining mold cavity 5 when closing the device 1. The result is a higher localized fiber density in the stack of fiber layers 6, on account of which the flow resistance to the matrix material is greatly increased there. A return flow of the fiber material into fiber layers 6 which have not yet been impregnated is prevented on account thereof, and homogeneous impregnation of the fiber layer stack is produced together with the uniformly produced flow front.

As an example of a fiber-composite component according to the invention, FIG. 4 shows a leaf spring 18 in the end portions 20 of which an increased fiber density is present. The fiber content in the end portions is 65% to 75%. By contrast, in the central portion 19 the fiber content is only 55% to 65%. The flow ducts of the first type 12 and of the second type 13 are also conjointly depicted together with the finished component. In the case of the illustrated leaf spring 18, the matrix regions 22 can be seen, which depict the flow ducts of the second type 13. These pure matrix regions in which no fiber material is present may be removed for example by abrasion, in a further processing step after the leaf spring 18 has been demolded. However, depending on the field of application of the leaf spring 18, the matrix regions 22 may also remain on the leaf spring 18. It is also possible for the properties of the leaf spring 18 to be modified by way of a suitable arrangement of these matrix regions 22.

As has already been explained above, it is the purpose of the flow ducts of the first type 12 and of the flow ducts of the second type 13 to distribute the matrix material within the mold cavity 5 such that uniform impregnation of the fiber layers 6 is performed. This may be controlled in particular in that the cross-sectional areas of the flow ducts of the first type 12 or of the flow ducts of the second type 13 are selected in a suitable manner. The cross-sectional areas here may vary in the extent direction of the flow ducts 12, 13; however, variable cross-sectional areas may also be selected for each individual flow duct 12, 13.

It has proven particularly advantageous for the cross-sectional areas of the flow ducts of the second type 13 to be reduced as the distance from the gate 4 increases. This is schematically shown in the plan view in FIG. 5. The gate 4 here is not explicitly illustrated. The mold cavity 5, on its inner walls 8, is provided with flow ducts of the second type 13. Starting from the gate 4, which in the sheet plane would be disposed on the left side, toward the peripheral region 14 of the mold cavity 5, the cross-sectional area of the flow ducts of the second type 13 continuously decreases. Moreover, the flow ducts of the second type 13 are disposed so as to be symmetrical to a central longitudinal plane 21 of the mold cavity 5. The central longitudinal plane here is defined by the directions X and Z and subdivides the mold cavity 5 into two symmetrical halves.

On account of the variation of the cross-sectional area of the flow ducts of the second type 13, the flow of the matrix material may be controlled in a targeted manner. In this exemplary embodiment, the cross-sectional area decreases in a linear manner. Depending on the boundary parameters, a progressive or regressive profile of the decrease of the cross-sectional area may also be meaningful. This mainly depends on the flow properties of the matrix material and on the geometry of the fiber-composite component. The later demolding capability of the finished fiber-composite component or the mechanical resilience of the matrix regions 22 also play a part in the selection of the specific design of the cross-sectional areas of the flow ducts 12, 13. The exact design of the flow ducts 12, 13 thus has to be selected on an individual-case basis.

### REFERENCE SIGNS

1—Device
2—Upper die
3—Lower die
4—Gate
5—Mold cavity
6—Fiber layer
7—Spreading directions
8—Inner wall
9—End region
10—Trapped air
11—Void region
12—Flow duct of the first type
13—Flow duct of the second type
14—Peripheral region
15—Protrusions
16—Filling duct
17—Distribution duct
18—Leaf spring
19—Central portion
20—End portion
21—Central longitudinal plane
22—Matrix region

1. A device for a resin-injection process for manufacturing an elongate fiber-composite component, in particular a leaf spring for a motor vehicle, having an upper and a lower die which collectively form a mold cavity for receiving a fiber-layer stack, wherein the inner contour of the mold cavity substantially corresponds to the outer contour of the fiber-composite component to be produced, having a gate for introducing a matrix material into the mold cavity which is disposed in a central region of the device, wherein flow ducts for conveying matrix material are provided on the inner walls of the mold cavity, wherein flow ducts of a first type, proceeding from the gate, extend in a longitudinal direction of the mold cavity toward the peripheral regions of the mold cavity, and having an outlet for attaching a vacuum pump, wherein means for increasing the fiber density in the end regions of the fiber-layer stack are provided in the peripheral regions of the mold cavity.

2. The device as claimed in claim 1, wherein flow ducts of a second type, which extend along a height direction of the mold cavity so as to branch out from the flow ducts of the first type, are provided.

3. The device as claimed in claim 2, wherein the flow ducts of the second type are disposed so as to branch out from the flow ducts of the first type in parallel with a demolding direction.

4. The device as claimed in claim 2, wherein the flow ducts of the second type are uniformly spaced apart in the longitudinal direction of the mold cavity.

5. The device as claimed in claim 1, wherein the flow ducts of the first and/or second type have variable cross-sectional areas.

6. The device as claimed in claim 5, wherein the average cross-sectional area of a flow duct of the second type is smaller the more distant the flow duct of the second type is disposed from the gate.

7. The device as claimed in claim 1, wherein the flow ducts are disposed so as to be symmetrical to the central longitudinal plane of the mold cavity.

8. The device as claimed in claim 1, wherein one or a plurality of inserts for reducing the mold cavity volume are provided as means for increasing the fiber density.

9. The device as claimed in claim 1, wherein protrusions for reducing the mold cavity volume are provided on the inner walls of the upper and/or lower dies as means for increasing the fiber density in the peripheral regions of the mold cavity.

10. A method for manufacturing elongate fiber-composite components, in particular leaf springs for a motor vehicle, comprising the following method steps:
providing a stack of a plurality of cut-to-size fiber layers;
placing the fiber-layer stack in the mold cavity of a die comprising an upper die and a lower die;
closing the die;
introducing matrix material into the mold cavity of the die through a gate which is disposed in a central region of the die, wherein the matrix material penetrates into the fiber layers and is simultaneously directed along flow ducts on the inner walls of the mold cavity, such that the stack of fiber layers is uniformly impregnated;
curing the resin while applying pressure and heat, wherein an elongate fiber-composite component is completed,
wherein a higher fiber density is produced in the end regions of the fiber-layer stack than in the remaining regions when closing the die.

11. The method as claimed in claim 10, wherein additional fiber pieces are introduced into the end regions of the stack when providing the stack of fiber layers.

12. The method as claimed in claim 10, wherein the end regions of the stack of fiber layers, on account of peripheral regions of the die which have a reduced height, are more heavily compressed than the remaining regions when closing the die.

13. An elongate fiber-composite component, in particular a leaf spring for a motor vehicle, having a central portion and end portions which are spaced apart by the central portion, wherein the end portions have a higher fiber content than the central portion.

14. The fiber-composite component as claimed in claim 13, wherein the fiber content in the central portion is 50% to 65%, and in the end portions 60% to 75%.
